(19) United States
(12) Patent Application Publication
(10) Pub. No.: US 2005/0174031 A1
(43) Pub. Date: Aug. 11, 2005

(54) Picture display device with reduced deflection power

(75) Inventor: Boris Skoric, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/516,989

(22) PCT Filed: May 22, 2003
(86) PCT No.: PCT/IB03/02238

(30) Foreign Application Priority Data
Jun. 7, 2002 (EP) 020772273
Dec. 5, 2002 (EP) 02081163

(51) Int. Cl. H01J 29/00

(52) U.S. Cl. 313/364; 313/440

(57) ABSTRACT

A picture display device comprises a cathode ray tube (1) with an elongated display screen (8) and a deflection system (9) for deflecting electron beams. The display screen is substantially rectangular with a long and a short axis. The line scanning direction is parallel to the long axis of the display screen. The cathode ray tube comprises a neck portion and between the screen and the neck portion a cone portion (3, 3a). This cone portion has an aspect ratio (ratio of x and y dimension, x/y ratio), which is near the neck below unity and changes to above unity closer to the screen as a function of z.

### BACKGROUND OF THE INVENTION

The invention relates to a picture display device comprising a cathode ray tube comprising an elongated display screen with a long axis and a short axis, a cone portion, a neck portion comprising means for generating three in-line electron beams, and a deflection system mounted on said cone portion for generating electromagnetic fields for deflecting said electron beams across the screen, wherein a line scanning direction is parallel to the long axis of the display screen.

U.S. Pat. No. 5,962,964 discloses a picture display device having CRT that comprises a cone portion whose cross section varies gradually from a circular shape at the neck end of the cone portion to a substantially rectangular shape at the display screen end of the cone portion.

The deflection system can therefore be positioned closer to the envelope of the electron beam(s) than within CRTs whose cone have circular cross sections. Magnetic losses are thereby reduced and as a result less deflection power is needed.

According to U.S. Pat. No. 5,962,964 deflection power consumption reductions between 17% and 25% can be achieved.

There is nevertheless a wish to further reduce the power consumption of the deflection system.

### SUMMARY OF THE INVENTION

It is an object of the invention to provide a picture display device with further reduction of the deflection power.

To this end, in accordance with an aspect of the invention, the picture display device is characterized in that a cross-section of the cone portion comprises a first section, near the neck portion, having a long axis and a short axis transverse to each other, wherein the short axis is parallel to the long axis of the display screen, the outer circumference of the cone portion having a second section, further away from the neck, having a long axis and a short axis transverse to each other, wherein the short axis is parallel to the short axis of the display screen.

The present invention enables a further reduction of deflection power.

In known designs the cone portion shows a cross-section in which the aspect ratio, i.e. the ratio between the x- and y dimensions, wherein the x-direction is parallel to the long axis of the display screen, which is also parallel to the line scanning direction, changes gradually from the aspect ratio of the neck (usually 1), to the aspect ratio of the display screen (e.g. 4/3 or 16/9). In the cathode ray tubes in accordance with the invention a part of the cone portion near the neck has a more or less rectangular cross-section of which the long axis and short axis are oriented such that the long axis is not parallel to the long axis of the display screen, but the short axis is parallel to the long axis of the display screen. Although it seems strange and counterintuitive to start the cone portion with a first section which actually has the ‘wrong orientation’, the inventors have realized that by reversing the long and short axis, for a first section of the cone portion, near the neck portion, i.e. for the part in which the initial deflection of the electron beams is generated by the deflection system, deflection power can be further reduced. The invention makes it possible to bring the line deflection coils on average closer to the deflected electron beams there where the initial deflection takes place. A major part of the deflection power is needed for the line deflection coils. The possible reduction in line deflection power carries a cost, namely the cost of a somewhat increased distance between the deflected electron beams and the frame deflection coils thereby increasing the required frame deflection power, but in total, a reduction of deflection power is obtainable.

Preferably, the minimum value of the aspect ratio between the outer dimension of the cone portion along a direction parallel to the long axis of the display screen and outer dimension perpendicular to the long axis of the display screen is between 0.60 and 0.95, most preferably between 0.70 and 0.90.

The aspect ratio of the screen itself is e.g. 4/3 or 16/9. The cone portion has a part near the neck portion for which said aspect ratio is smaller than 1 and the aspect ratio of the cone portion changes, going from the neck towards the screen, into a value larger than 1, and near the display screen attains a value of or near the aspect ratio of the screen (e.g. 4/3 or 16/9, depending on the design of the screen of the cathode ray tube).

Too small a ratio (smaller than 0.70 and even more so for values smaller than 0.60) will lead to rather complex designs of the cone portion forcing substantial changes in the designs of deflection units and deflection coils. Values of larger than 0.95 will give a relatively small positive effect.

The economy of deflection power (a further reduction of several percent of the deflection power, in comparison to prior art is possible) may be used advantageously to increase the maximum deflection angle of the electron beam(s). In preferred embodiments, maximum deflection angles larger than or equal to 1200 are realized. This is useful to build more slim CRTs.

### BRIEF DESCRIPTION OF THE DRAWINGS

These and further aspects of the invention will be explained in greater detail by way of example and with reference to the accompanying drawings, in which:

FIG. 1 is a sectional view of a picture display device according to an embodiment of the invention;

FIG. 2 is a sectional view of the display window;

FIG. 3 illustrates the outer circumferences of a cone portion of a CRT for or of a display device in accordance with the invention;

FIG. 4 illustrates in graphical form the aspect ratio as function of z in case the in-line plane is oriented parallel to the long axis;

FIG. 5 illustrates the aspect ratio as a function of z for several embodiments of the invention z in case the in-line plane is oriented parallel to the long axis;

FIG. 6 shows the aspect ratio A as a function of z, for a 32″, 16:9, 105° deflection tube, in case of the in-line plane being oriented parallel to the short axis; and

FIG. 7 shows the aspect ratio A as a function of z, for a 32″, 16:9, 120° deflection tube, in case of the in-line plane being oriented parallel to the short axis of the screen.

The Figures are not drawn to scale. In general, like reference numerals refer to like parts.

### DETAILED DESCRIPTION OF PREFERRED EMBODIMENTS

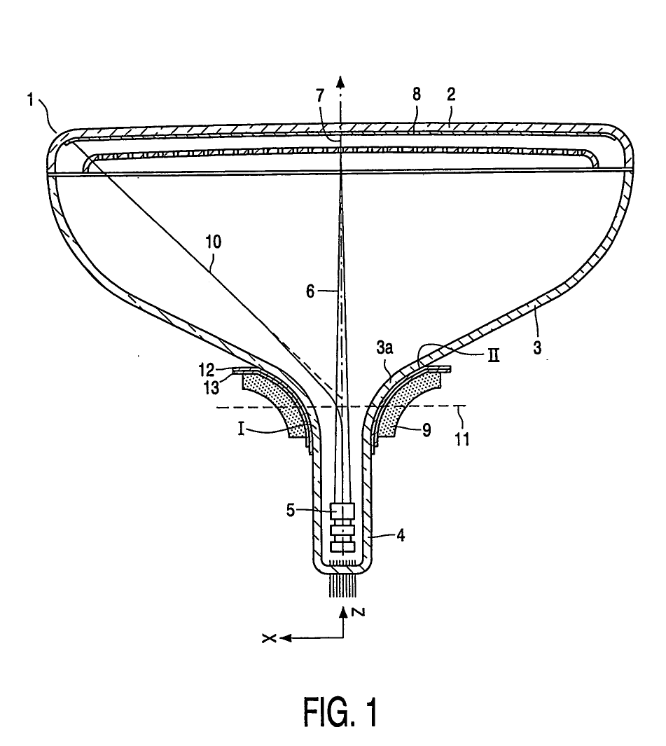

A picture display device according to a preferred embodiment of the invention is shown in FIG. 1. The display device comprises a cathode ray tube 1, which includes a display window 2, a cone portion 3, and a neck portion 4 (or neck as it is called herein below). In the neck 4, there are means 5 for generating three in-line electron beams 6, oriented within a so-called in-line plane. As a means for generating an electron beam an electron gun is usually employed. The inner surface of the display window 2 comprises a large number of phosphor elements, which form a display screen 8. When one or more of the electron beams 6 hit phosphor elements, the latter become phosphorescent, thereby creating a visible spot on the display screen 8. In the undeflected state, the middle one of the electron beams 6 substantially coincides with the tube axis 7. The direction of the tube axis is herein below denoted by the z-direction. The direction along the long axis of the display screen is denoted by the x-direction, the direction along the short axis of the display screen by the y-direction. The line scanning direction (i.e. the direction in which scanning with the highest frequency takes place) is parallel to the long axis (the x-direction) of the display screen. On its way to the display screen 8, the electron beams 6 are deflected by means of a deflection system 9 covering a part 3a of the cone portion 3. It is in particular this part 3a of the outer contour that the invention relates to. Said deflection system 9 comprises a line deflection subsystem 12 and a frame deflection subsystem 13, in order to create a two-dimensional picture on the display screen 8. In this exemplary embodiment, the deflection system 9 is made up of sets of coils, one set for the line deflection subsystem 12 and another set for the frame deflection subsystem 13. The outer circumference of the cone portion comprises a first section I near the neck and a second portion II further away from the neck, more towards the screen.

Plane 11 is the so-called deflection plane. The deflection plane is the plane from which the deflected beams seem to originate, as is schematically shown for deflected beam 10. The figure also indicates the x-direction, i.e. the direction along the long axis of the display screen and the z-direction. The z-coordinate of the deflection plane is usually (and herein below) taken to be zero, with positive values of z being closer to the display screen.

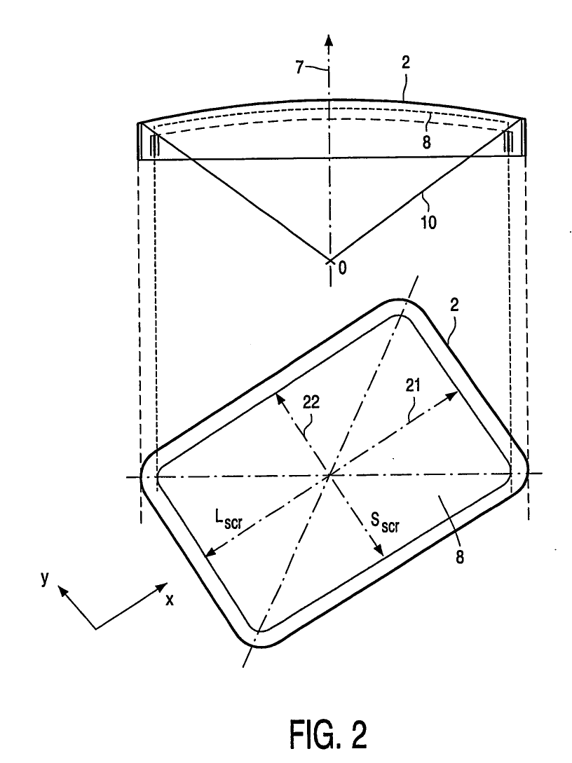

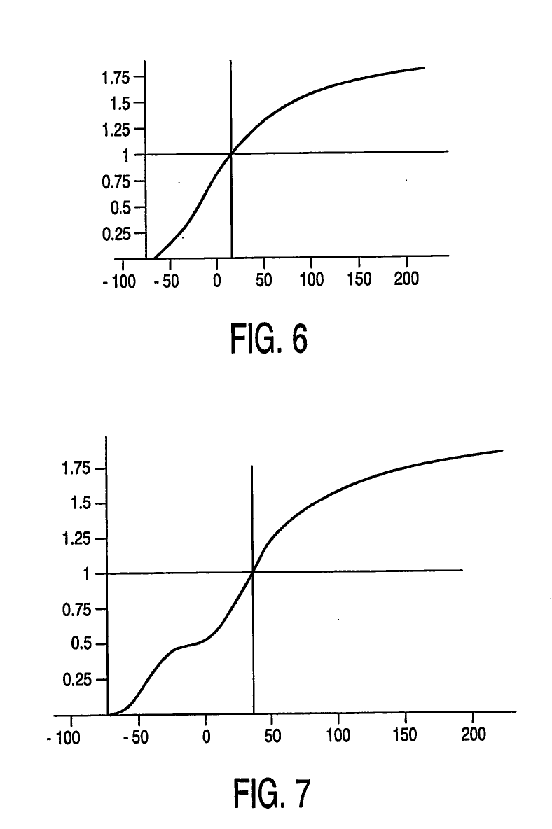

In conventional CRTs the in-line plane is oriented parallel to the long axis of the display screen. In the display device according to the invention the in-line plane may be oriented either parallel to the long axis 21 (a situation relating to FIGS. 2-5) or parallel to the short axis 22 (relating to FIGS. 6-7).

As can be seen from FIG. 2, the display screen 8 has an elongated shape with two perpendicular axes of symmetry a long axis 21 whose length is I_{scr} and a short axis 22 whose length is S_{scr}. In order to quantify the amount of elongation of the display screen 8, the aspect ratio of the display screen 8 is defined as A_{scr}=L_{scr}/S_{scr}. Depending on the design A_{scr} is usually 4/3 (1.333) or 16/9 (1.78).

The invention relates to the aspect ratio of the cone portion, and more in particular the cone portion under the deflection unit. In standard designs the outer circumference of the cone portion is either circular (i.e. having an aspect ratio of 1, in which case the inside of the deflection unit is also substantially circular) or changes gradually from circular (aspect ratio 1) to rectangular in accordance with the aspect ratio of the display screen.

In a picture display device in accordance with the invention the aspect ratio of the cone portion is for a first part of the cone portion, i.e. a part near the neck, less than 1, changing into a value larger than 1 as a function of z.

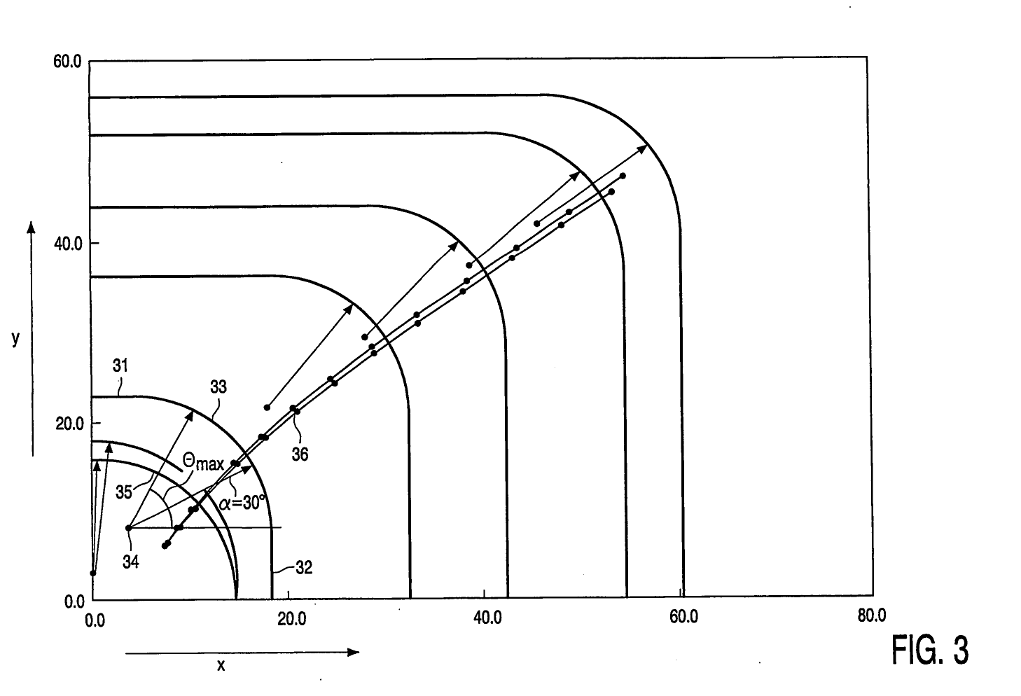

FIG. 3 illustrates such a design. The figure shows as a function of z the outer circumference of the cone portion. Each outer circumference comprises in this example a substantially horizontal part 31 (i.e. extending along the x- or scanning direction) with a large radius of curvature, a substantially vertical part 32 (i.e. extending along the y or frame direction) with a large radius of curvature, and a corner part 33 with a center of curvature 34. The smallest cross-section shown is the part nearest the neck portion which in this example is circular, so that the first cross-section is circular, the next smallest one is near the neck portion, the largest ones are nearest the screen, i.e. for the largest values of z. For a number of cross-sections the radius of curvature of the corner part 34 is shown, where the angle θₘₐₓ that is the angle formed by a line between the center, i.e. (x,y)=(0,0) and the largest radius of the cross-section (i.e. the largest value of x²+y² for that particular z-value) is indicated.

As can be seen for small values of z, i.e. in FIG. 3 the smallest, innermost cross sections, corresponding to those parts of the cone nearest to the neck portion, the y-dimension is larger than the x-dimension, for instance for the cross-section to which the numbers 31 to 34 are attached, the x:y ratio is 18:22. This means that the outer circumference of the cone portion is larger in the y-direction than in the x-direction, i.e. the cone is elongated in the frame direction. For the largest cross-sections (highest values of z), the x:y aspect ratio is larger than 1, for instance for the largest cross-section shown here the x-dimension is 60, while the y-dimension is 56. This change in form of the outer circumference from a form elongated in the frame direction (near the neck portion), to a form elongated in the scanning direction (towards the screen) enables a reduction of the power dissipation. The line scanning deflection coils can be brought closer to the electron beams. Lines 36 show the positions of the deflected beams in maximum deflection, respectively for 6% overscan. In this preferred embodiment the neck portion itself is circular.

The angle θₘₐₓ (i.e. the angle that the arrows form with the x-axis) changes from an angle well over 45 degrees (near the neck portion), and in this example starting with a value of 90 degrees, to an angle below 45 degrees, approaching the angle corresponding to the arctangent of the aspect ratio of the display screen A_{scr} for z-positions near the display screen.

The following mathematical construction method (without being restricted to such a method) can be used to calculate the outer contour. It is assumed that the radii of curvature of parts 31, 32 and 34 remain the same throughout the cone (but usually not equal to each other, since the radii of curvature of parts 31 and 32 are much larger than that of part 33). The radius of curvature of part 33, the corner part is set to be equal to the radius of curvature of the neck pat, to obtain a smooth transition from the neck part to the cone portion. A smooth transition increases the strength of the cone. For each point on the line 36, i.e. the position of the deflected beams, the locations of the center points 34 are found by drawing a line perpendicular to the round part 34, through line 36 and that has an angle of 300 with the x-axis. In the figure this is indicated by α=30°. Using this mathematical construction (but many more are possible, for instance the radii of curvature may be made z-dependent, or the corner may be chosen to slightly depart from a purely circular arc form) devices within the concept of the invention have an angle α which is smaller than 45°. When the angle between the x-axis and a line through the center points 34 and the line 36 is less than 45° in particular approximately 30°, the distance in the x-direction between the outer contour and the line 36 can be made small, enabling the line deflection coils to be brought close to the electron beams, reducing the deflection power, be it at a cost of increasing the distance along the y-direction.

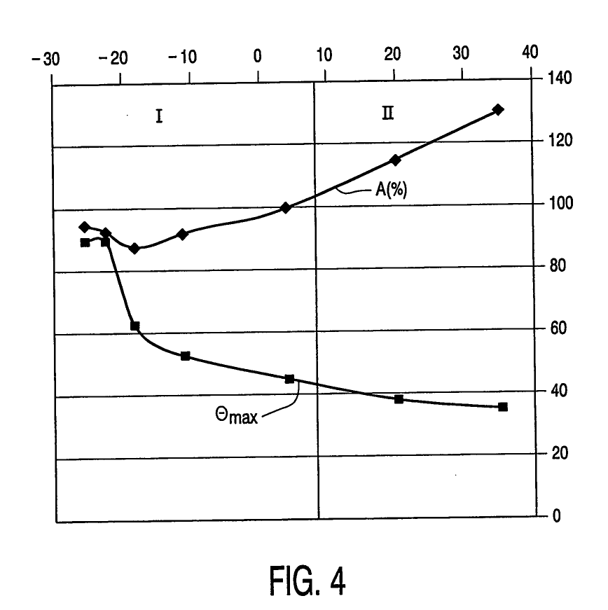

For the example schematically shown in FIG. 3, FIG. 4 shows as a function of z (in mm, where z=0 corresponds to the z-value of deflection plane 11 as shown in FIG. 1), the aspect ratio A of the cross-section of the cone (in percentage, i.e. 100% is an aspect ratio of 1) and the angle θₘₐₓ (in degrees). As can be seen the aspect ratio changes from 1 to values smaller than 1 in a first section I to a value larger than 1 in a second section II. The angle θₘₐₓ changes from an angle larger than 45 degrees (roughly 90 degrees in this preferred embodiment) to an angle smaller than 45 degrees. The first section I and the second section II are indicated in FIG. 4, the vertical line indicating the border between the first and second section. This borderline lies preferably at or near (within roughly 3 cm) of the deflection plane.

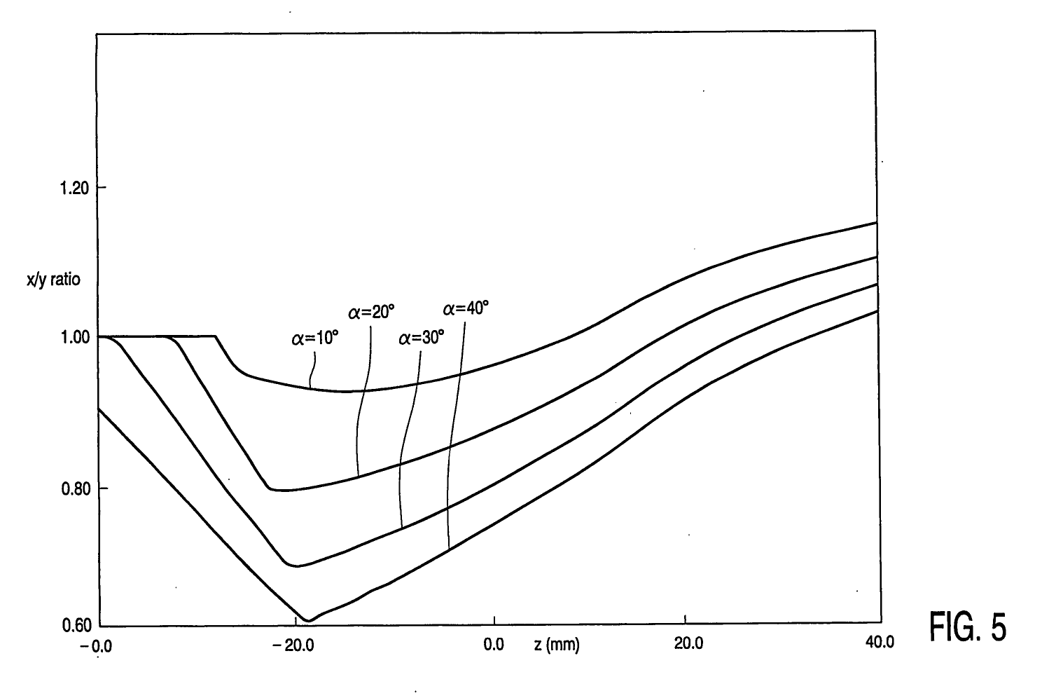

FIG. 5 shows for various angles of a as indicated in the figure, the aspect ratio as a function of z, where z=0 corresponds to the deflection plane, negative values of z indicate points closer to the neck portion, and positive values of z are nearer to the screen. All of these examples fall within the framework of the invention, since in all of the examples the aspect ratio (the x/y ratio) changes from a value smaller than unity for a part (I) near the neck, to a value above unity with increasing z (in part II), i.e. getting closer to the screen. It is preferred, however, that the aspect ratio in the first part (I) has a minimum value of between about 0.70 and about 0.90, in this figure corresponding to an angle between 30 and 15 degrees. Too small a minimum value of the aspect ratio would require relatively large changes in design of the deflection unit, and contour of the cone, whereas a value close to one would give a relatively small positive effect. Preferably the border between the parts I and II lies near the deflection plane, near being within 30 mm (seen in the z-direction) from the deflection plane.

In the Figures discussed herein before the aspect ratio as a function of the longitudinal position (z-axis) is presented for the case that the in-line plane is oriented parallel to the long axis (conventionally extending in the horizontal direction) of the screen. This orientation of the in-line plane with respect to the screen is called normal scan. CRT tubes having a shape as discussed require a minimal energy for deflecting the electron beams across the screen.

In FIGS. 6 and 7 shapes are presented for CRT tubes in which the in-line plane is oriented parallel to the short axis of the screen (which is conventionally the vertical direction).

FIG. 6 shows the aspect ratio A as a function of z (expressed in mm), for a 32″, 16:9, 105° deflection tube, in case of the in-line plane being oriented parallel the short axis of the screen for the red beam (the electron beam deflected to hit the red phosphor elements on the screen) deflected to the corner of the screen. The vertical line in the Figure corresponds to with the z-position for which the aspect ratio is equal to 1, which is located under the deflection unit.

The z-values left of the vertical line (corresponding to the first portion I) have an aspect ratio A smaller than 1, even below 0.2, and z-values on the right hand sight (portion II) have an aspect ratio A larger or equal to 1. Such a longitudinal profile provides an optimal CRT shape with respect to the minimal required deflection energy for this tube.

FIG. 7 shows the aspect ratio A as a function of z (expressed in mm), for a 32″, 16:9, 120°-deflection tube, in case of the in-line plane being oriented parallel to the short axis of the screen. The vertical line in the Figure corresponds with the z-position for which the aspect ratio is equal to 1. The z-values left of the vertical line (corresponding to the first portion I) have an aspect ratio A smaller than 1 and z-values on the right hand sight (portion A) have an aspect ratio A larger than or equal to 1. Such a longitudinal profile provides an optimal CRT shape with respect to the minimal required deflection energy for this tube.

It will be clear that many variations are possible that fall within the scope of the invention. The protective scope of the invention is not limited to the embodiments described.

In short the invention may be described as follows:

A picture display device comprises a cathode ray tube 1 with an elongated display screen 8 and a deflection system 9 for deflecting electron beams. The display screen 8 is substantially rectangular with a long and a short axis. The line scanning direction is parallel to the long axis of the display screen. The cathode ray tube comprises a neck portion and a cone portion positioned between the screen and the neck portion. This cone portion has an aspect ratio (ratio of x and y dimension), which is near the neck below unity (aspect ratio<1) and changes to above unity (aspect ratio>1) further away from the neck, i.e. closer to the screen.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements. The means for generating three in-line electron beams may for instance be constituted by an electron gun in which (as in standard designs) three electron beams are generated but electrodes are common, or by three separate electron guns. However, other means for generating electron beams may be used, departing from the standard designs.

1. A picture display device comprising
a cathode ray tube comprising an elongated display screen with a long axis and a short axis, a cone portion, a neck portion comprising means for generating three in-line electron beams, and
a deflection system mounted on said cone portion for generating electromagnetic fields for deflecting said electron beams across the screen, wherein a line scanning direction is parallel to the long axis of the display screen,
a cross-section of an outer circumference of the cone portion comprising a first section, near the neck portion, having a long axis and a short axis transverse to each other, wherein the short axis is parallel to the long axis of the display screen (aspect ratio <1), the outer circumference of the cone portion having a second section, further away from the neck, having a long axis and a short axis transverse to each other, wherein the short axis is parallel to the short axis of the display screen (aspect ratio ≧1).

2. A picture display device as claimed in claim 1, wherein the three in-line electron beams are located in an in-line plane, the in-line plane being parallel to the long axis of the display screen, and for said first section the minimum value of the aspect ratio between the outer dimension of the cone portion along a direction parallel to the long axis of the display screen and outer dimension perpendicular to the long axis of the display screen being between 0.60 and 0.95, preferably between 0.70 and 0.90.

3. A picture display device as claimed in claim 1, wherein the three in-line electron beams are located in an in-line plane, the in-line plane being parallel to the short axis of the display screen, and for said first section the minimum value of the aspect ratio between the outer dimension of the cone portion along a direction parallel to the long axis of the display screen and outer dimension perpendicular to the long axis of the display screen being between 0.20 and 0.95, preferably between 0.70 and 0.90.
